(19) United States
(12) Patent Application Publication
(10) Pub. No.: US 2004/0030629 A1
(43) Pub. Date: Feb. 12, 2004

(54) System and method for portfolio valuation using an age adjusted delinquency rate

(76) Inventors: Charles Freeman, Tampa, FL (US); Xingxiong Xue, Tampa, FL (US)

Correspondence Address: Michael J. Scheer, DICKSTEIN SHAPIRO MORIN & OSHINSKY LLP, 41st Floor, 1177 Avenue of the Americans, New York, NY, 10036-2714, US

(21) Appl. No.: 10/462,773

(22) Filed: Jun. 17, 2003

Related U.S. Application Data
(60) Provisional application No. 60/389,227, filed on Jun. 17, 2002.

(51) Int. Cl. G06F 17/60

(52) U.S. Cl. 705/36; 705/38

(57) ABSTRACT

A system and method for determining performance characteristics of loan portfolios. The system and method employs a delinquency rate analysis to perform a valuation of a portfolio using a new statistic obtained by integrating the age effects with the delinquency rates. A fictitious vintage of loans known as a proxy vintage is created from historical industry data and the calculated average delinquency rate is assigned at all the ages. A portfolio's credit performance is then evaluated by combining the distribution of the variance of age with the historical vintage information. An equivalent base delinquency rate of a vintage is generated as a derived delinquency rate the portfolio would have had at a base age. Finally, an age adjusted delinquency rate is determined which is a weighted average of the equivalent base rates of all the vintages in a portfolio.

### CROSS REFERENCE TO RELATED APPLICATIONS

This application claims priority to U.S. Provisional Application No. 60/389,227, filed on Jun. 17, 2002 the entirety of which is incorporated herein by reference.

### FIELD OF THE INVENTION

The present invention generally relates to systems and methods for the valuation of portfolio of mortgages, and more particularly to systems and methods for the valuation of portfolio of mortgages using an age adjusted delinquency rate.

### BACKGROUND OF THE INVENTION

There are several approaches that are currently used to measure the credit performance of a portfolio. These measurements are used either for valuation of the portfolio or for comparison to other portfolios (or benchmarks). Each type of portfolio valuation method has benefits and issues associated with it. Choosing the best statistic for a particular question becomes an important consideration.

One approach that is used to evaluate the performance of a portfolio of mortgages is to measure the delinquency rate of the mortgages contained in the portfolio. Delinquency rate R(t) is the ratio of the number of the delinquent loans to the number of total loans at a particular time t. The main benefit of the delinquency rate approach is its ease of calculation and quick comparability. However, it must be borne in mind that the delinquency rate of a portfolio is actually a function of loan characteristics: R(t, a, b, c, . . . ), where a, b, c, . . . represent those characteristics. Some of the characteristics a, b, c . . . that affect the delinquency rate include the particular type of loan (e.g., adjustable rate versus fixed rate, conventional versus jumbo loan) geographic distribution and age of the loans being evaluated. Comparing two portfolios using the delinquency rate R(t) without considering those characteristics, may result in misleading conclusions.

One example of a characteristic that should be taken into consideration when assessing a portfolio's delinquency rate is the respective ages of the loans in the portfolio. If the majority of a portfolio is made of young loans, the overall delinquency rate is predictably low, despite the portfolio's relative credit profile. A quick solution to these potentially misleading results is to value the credit performance of some sub-portfolios, instead of attempting to value the whole portfolio. These sub-portfolios can be created by grouping loans that share some significant characteristics. For example, one can group government loans and conventional loans separately, or view loans in states of New York, California and all other states separately. Although this technique improves details, there is currently no unbiased estimator of the credit quality of the whole portfolio. Moreover, some characteristics such as age of a loan are more difficult to deal with because they will change during the life of a loan.

Vintage analysis is a technique that is used to group loans of similar ages and thus produce more accurate assessments of the performance of a portfolio. Vintages are a detailed table (often graphed) that segments a portfolio into cohorts (subsets) in which each loan shares a short period of time in which it was originated. For example, all loan in a portfolio that were originated in 1999 can be grouped into a single cohort. Typically, the variation of age between loans in each cohort is ignored. Instead of considering each individual loan's age, vintage analysis uses the age of each cohort as one key parameter affecting the loan performance. The delinquency rate is then tracked by the age, from time of origination.

The main benefit of using a vintage analysis is that the age effect on the delinquency performance is clearly shown by the historical performance of the cohorts. As a consequence, the comparison between vintages at a particular age is straightforward by comparing their trend lines of delinquency rates. The vintage approach is quite popular. However, for a portfolio composed of several vintages, it is a challenge to evaluate the credit performance of the entire portfolio by the information weaned from the separate vintages.

Crus Classes is one part of Dynamic Underwriting System described in U.S. Pat. No. 6,249,775 assigned to the assignee of the present invention. As described above, traditional vintage analysis ignores the age difference of loans in each vintage (cohort). Typically, the vintages of the prior art were defined on year boundaries. Thus, a loan originated in January of a particular year, would be grouped together with a loan issued in December of that same year. However, this difference is too significant to be ignored in many cases. Crus Classes developed a technique called “moving sum” which effectively takes account of the deviation of the age of the loans in each vintage. However, although an improvement, Crus Classes does not yet provide a solution to the challenge of assessing the credit performance of the entire portfolio mentioned in the above.

One further technique for assessing the value of a portfolio is using the credit scores of the individuals on the loans. A credit score measures an individual consumer's credit risk as defined by willingness to pay, based on a logit or probit regression of that individual past payment behavior as indicated in their credit history. The credit score system typically defines “bad performance” as one certain kind of probability of default on any tradeline/obligation of that borrower in the coming two years. The credit score model then assigns each borrower or potential borrower a score which reflects that probability.

A significant difference between delinquency rate analysis and credit score analysis is that the former is a measure of the credit performance of loans in a portfolio at a particular time while the later is a measure of each borrower's expected future credit performance during a future time period. By analyzing each individual borrower's future credit performance, the lender can infer its portfolio's future credit performance. Credit score analysis is a useful tool for credit risk management in the consumer lending business (e.g., credit cards) because this advanced modeling technique can accurately evaluate (rank) consumers' credit worthiness. This technique has a proven predictive power with respect to future bad performance. It is interesting to note that when using a credit score analysis, the consumer lending business sometimes does not distinguish between the risk of the borrower (credit score) and the risk of the loan.

Although credit score analysis can be applied to closed end loans, the difference between the risk associated with an individual person and the risk of one of his/her loans is too significant to be ignored. A credit score can not reflect the loan performance difference caused by the difference of the loan characteristics. An immediate consequence of this difference is that, for example, a credit score system could not explain why, with individuals with identical credit scores, an FHA mortgage loan and a conventional mortgage loan will perform totally differently. This is a significant weakness of credit score system. Another weakness is the credit score of the individual borrowers needs to be updated frequently, and such updates are expensive. Although the credit score technique works well for evaluating individual consumers, the average credit score of a portfolio does not work as well as a measure of the credit quality of that portfolio.

One other prior art method for predicting future performance of loan portfolios is known as the Roll-Rate Matrix Method. This method generates predictions based on the probability of a loan moving from one delinquency status to another status after a specified time period. This method uses both traditional delinquency measures and vintages.

### SUMMARY OF THE INVENTION

The present invention is a system and method for determining the performance characteristics of loan portfolios. The system and method employs a delinquency rate analysis to perform a valuation of a portfolio. The analysis of delinquency performance of portfolios is crucial for several disciplines including credit risk management, portfolio accounting, valuation for portfolio acquisition and the secondary marketing, hedging or trading of the portfolio. As described above, there are several different approaches that one can choose to use to value portfolios, and they are fundamentally quite different. The appropriate choice of method is very dependent on the question being asked. However, as described above, none of the prior art systems and methods results in a truly accurate and objective analysis of the credit performance of loan portfolios.

The system and methods of the present invention solves these deficiencies of the prior art and employs a new statistic that depicts the credit quality of a portfolio better than the other methods. The new statistic for determining portfolio performance is known as the Age Adjusted Delinquency Rate (“AADR”) and is obtained by integrating the age effects with the delinquency rates.

The present invention first quantifies the correlation between the delinquency rate of a vintage and its age. At each age of a vintage, the system calculates the empirical average delinquency rate. A fictitious vintage of loans is also created from historical industry data and the calculated average delinquency rate is assigned at all the ages. This fictitious vintage is called the proxy vintage of loans related to a particular mortgage program or product. The proxy vintage's delinquency rate at each age is the average of the of the delinquency rates of the vintages at that age and will serve as a benchmark for comparison.

Once the proxy vintage has been created, the system evaluates portfolio credit performance by combining the distribution of the variance of age with the historical vintage information. The method first develops a benchmark measure to compare vintage credit performance. The method employs two concepts in creating this benchmark. The first is a “base age” which, for mortgages, is set at 2 years old. The base age is used as a benchmark age of credit performance and can be set up by different choices. The second concept used in the benchmark is the “equivalent base delinquency rate” (“EBDR”) of a vintage. The EBDR is the derived delinquency rate the portfolio would have had at the base age. The EBDR is inferred from its current delinquency rate (when its age is other than the base age) collaborating with the experience of the proxy vintage. Consequently, EBDR of any vintages will reflect their credit performances at the same selected base age.

The final step in the process is to create the AADR. The AADR is a weighted average of the equivalent base rates of all the vintages in a portfolio. By creating the EBDR the present invention combines the information of the current rate of the vintage and its age into one single number. Further, by creating the AADR from the EBDR, the present invention is able to represent the credit performance as a single rate which actually reflects not only the delinquency rate but also the effect from the distribution of the age of the loans in the portfolio. As a consequence, the AADR is a best estimator for the credit quality of the portfolio, especially when the portfolio is composed of loans of varying vintages.

### BRIEF DESCRIPTION OF THE DRAWINGS

For the purposes of illustrating the present invention, there is shown in the drawings a form which is presently preferred, it being understood however, that the invention is not limited to the precise form shown by the drawing in which:

FIG. 1A illustrates a 30 days past due delinquency rate of a proxy vintage;

FIG. 1B illustrates a 60 days past due delinquency rate of a proxy vintage;

FIG. 1C illustrates a 90+ days past due delinquency rate of a proxy vintage;

FIG. 1D illustrates a foreclosure delinquency rate of a proxy vintage;

FIG. 2 depicts an empirical delinquency rate of a proxy vintage and a regression prediction;

FIG. 3 illustrates a process of the present invention for determining an age adjusted delinquency rate;

FIG. 4 depicts the process for predicting future delinquency rates using the quarterly change method;

FIG. 5 illustrates the process for predicting future delinquency rates using the average ratio prediction method;

FIG. 6 illustrates two predictions of future delinquency rates; and

FIG. 7 illustrates the system of the present invention.

### DETAILED DESCRIPTION OF THE INVENTION

Before discussing the details of the present invention, it will be useful to first discuss some of the terms used herein. Although there are some other details to the industry definitions for delinquency, as used herein, the generally accepted categories of delinquency rates are: 30 days past due (“30DPD”); 60 days past due (“60DPD”); 90+ days payment past due (“90DPD”); and “in foreclosure.” The term “delinquency rate” as used herein generically includes any loans in any one of these delinquency categories.

The use of the term “vintage” and its “age” are also consistent with the generally accepted definitions. One vintage of a particular year in a portfolio is all the loans originated in that calendar year in that portfolio. For example, the 1994 vintage is all the loans originated in the year 1994. In the examples illustrated below, seven vintages have been used, ranging from 1994 to 2000. The age of each vintage is the number of months starting from January of that year of the vintage. For example, at the end of June 1994, the age of the 1994 vintage is 6 months, while at the end of June 1995 its age is 18 months.

In the below examples, the age of the vintages is measured as of the end of the year 2000. For example, longest age is 84 months (vintage 1994) and shortest is 12 months (vintage 2000). Although the age is measured in months, the data employed is quarterly data. The delinquency rates of the months other than the quarters are inferred by linear interpolation. The historical data used herein was supplied by a private organization named LoanPerformance (formerly known as the Mortgage Information Corporation (MIC)). This data represents the historical credit performance information of up to twenty-eight million prime first mortgage loans. Historical loan performance data is available from other sources such as MICA.

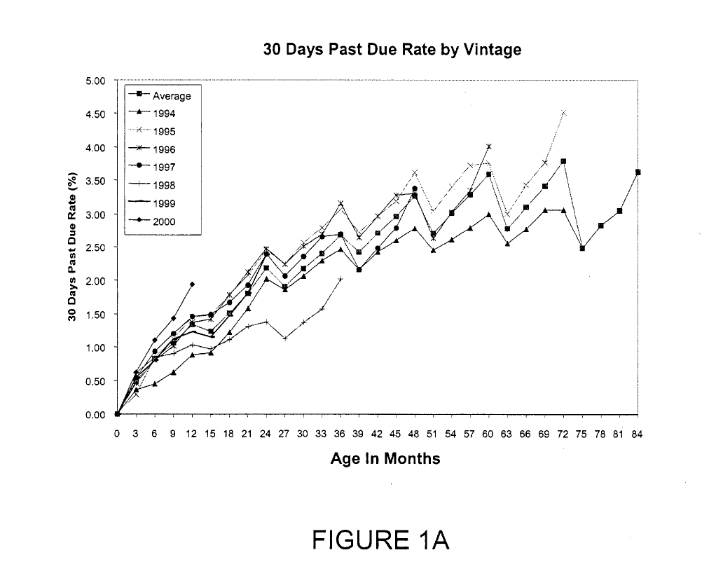

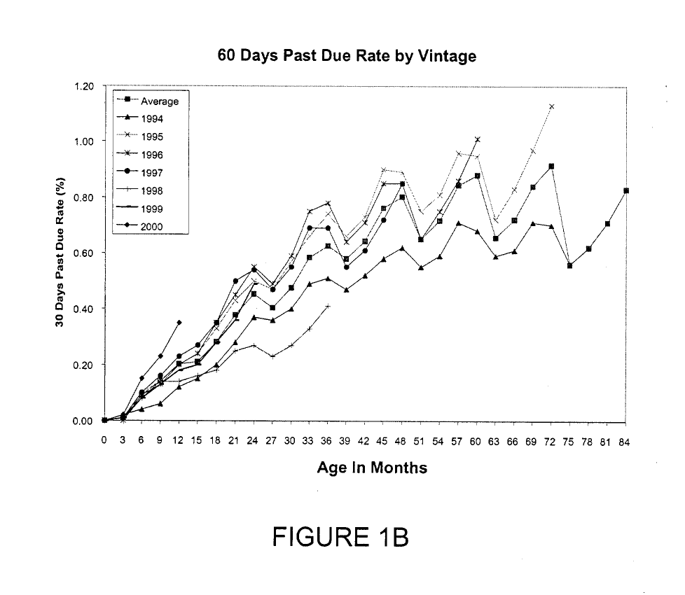

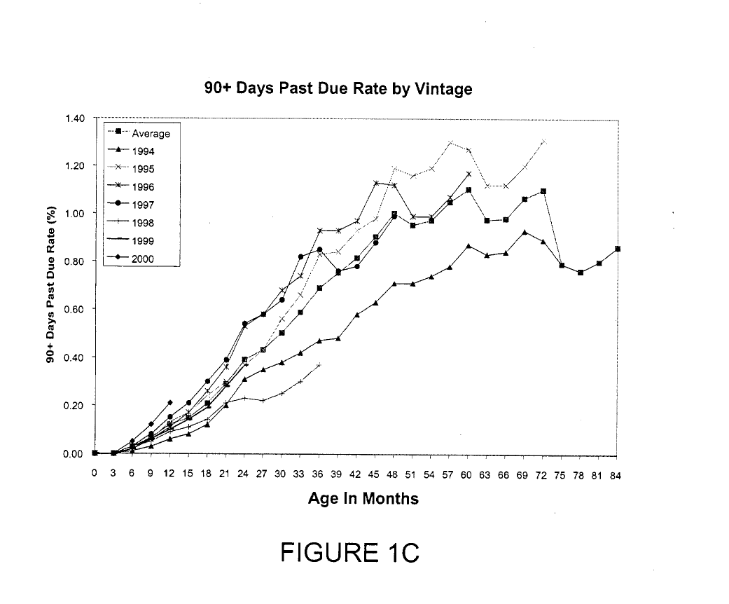

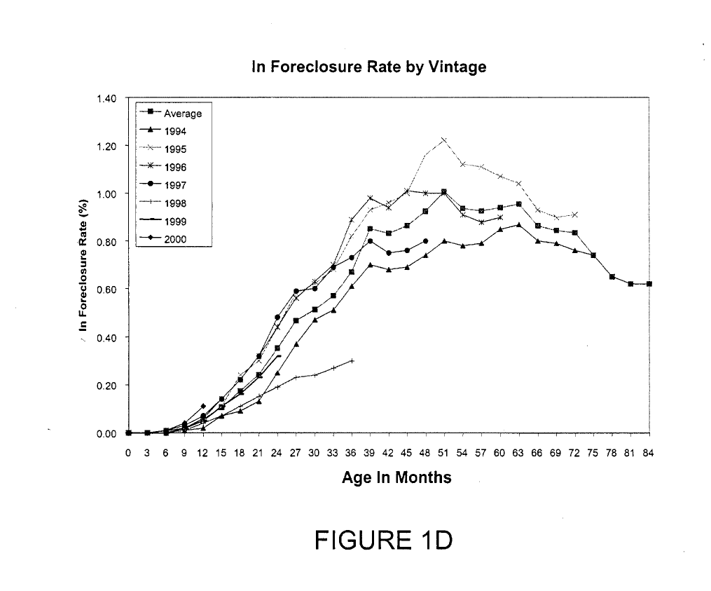

FIGS. 1A through 1D show the empirical delinquency rates by age for the seven vintages. FIGS. 1A through 1D depict the delinquency rate (as a percentage) for seven different vintages as a function of age. Specifically FIG. 1A illustrates the delinquency rate of 30 Days Past Due delinquencies. FIG. 1B illustrates the delinquency rate of 60 Days Past Due delinquencies. FIG. 1C illustrates the delinquency rate of 90+ Days Past Due delinquencies. FIG. 1D illustrates the delinquency rate of “in foreclosure” delinquencies. Although the delinquency rates at the same age varies from vintage to vintage, as seen in FIGS. 1A through 1D, the curves of delinquency rates by age for all of the vintages have a similar pattern.

The correlation between the curves illustrated in FIGS. 1A through 1D suggests that the random variable of delinquency rate is a function of age. A two step approach us used to estimate the age effect on the delinquency rate. First, the average delinquency rate at each particular age is used as an unbiased estimator of the delinquency rate at that age. Second, non-linear regression analysis is performed on the estimators against the age to find out that function. The data used in the examples herein is right censored data as the later vintages (e.g., 1999, 2000 vintages) do not have a full population of older loans. For example, the Average 30 DPD Rate at the age of 3 months=(Sum of 30 DPD Rates of 7 vintages from 1994 to 2000 at their age of 3 months respectively)/7, since all of the vintages have loans that are three months old. In contrast, the Average 30 DPD Rate at the age of 15 months=(Sum of 30 DPD Rates of 6 vintages from 1994 to 1999 at their age of 15 months respectively)/6. Only six of the vintages have loans that were 15 months old, the 2000 vintage did not have any loans that were 15 months old.

To fully use the information contained in the average delinquency rates by age, the present invention defines a “proxy vintage.” The proxy vintage is a fictitious portfolio that is composed of the calculated series of average delinquency rates of the underlying vintages at all ages. In other words, the performance of the proxy vintage represents the average credit performance of a vintage and hence can be used as a benchmark of credit performance. In the preferred embodiment, the proxy vintage is determined from as large a pool of historical data as is available. As described above, in a preferred embodiment, the present invention uses historical data from the LoanPerformance company. The company LoanPerformance updates the delinquency data behind the vintages monthly.

The proxy vintage's delinquency performance reveals the relationship between the delinquency rate and age. As described above, regression analysis is performed on the delinquency rate against its age. In the regression, the dependent variable is the delinquency rate. The independent variables are the months of age (Month), the square of the months of age (Mon_SQR) and dummy variables of seasonal effects: e.g., Mar_Effect, June_Effect and Sept_Effect. As known to those skilled in the art, Mar_Effect, June_Effect and Sept_Effect are well documented and accepted seasonal effects on mortgage delinquencies.

The seasonal effect is furthermore related to the age of the loan. Typically, there is no seasonal effect in the first year of the vintage. Also, the seasonal effect increases as the vintage gets older and the delinquency rate gets bigger. To measure the seasonal effect, the December performance is defined as the base with seasonal effect zero. The second year's effects from March, June and September are set as the base, which is the dummy variable. From the third year on, the seasonal effect increases by 20% each year. Table 1 is the results from the regression:

TABLE 1
Regression of Delinquency Rate on Age (in Month) for the Proxy
Vintage of Total Portfolio

| | R Square | Intercept | Mon_SQR | Month | Mar_Effect | June_Effect | Sept_Effect |
|---|---|---|---|---|---|---|---|
| 30 DPD | 0.99 | 0.2614 | −0.0007 | 0.0989 | −0.4789 | −0.3338 | −0.2058 |
| 60 DPD | 0.99 | −0.1004 | −0.0002 | 0.0303 | −0.1258 | −0.0965 | −0.0374 |
| 90+ DPD | 0.96 | −0.3804 | −0.0004 | 0.0456 | −0.0788 | −0.0806 | −0.0452 |
| FC | 0.97 | −0.5565 | −0.0005 | 0.0524 | 0.0042 | −0.0329 | −0.0324 |

Table 1 reveals some interesting characteristics of the proxy vintage. The data has very high R squares in the regression, that empirically confirms the high correlation between delinquency rate and the age of the loan (or vintage of loans). Negative coefficients of the square of the month of age (Mon_SQR), indicate that the base of the curve is a concave quadratic function. The concavity of the curve implies that the delinquency rate grows at a slower and slower rate, and even declines as the vintage matures. Table 1 shows a linearity of the increase of the delinquency rate at the younger ages, except for the seasonal effects. This is because the coefficients of the quadratic term are very small, hence it does not play a significant role when the proxy vintage is young.

From the curves illustrated in FIGS. 1A through 1D, it is clear that there is seasonal effect in the delinquency rate. March has the best credit performance and December has the worst. Table 1 shows that the 30 DPD rate in March of the second year is about 48 basis points lower than in the previous December, not considering the 10 basis points increase due to the age effect. As the stage of delinquency (30, 60, 90+ DPD) progresses (gets worse), the seasonal effect becomes smaller. In fact, the seasonal effect to the foreclosure rate is insignificant.

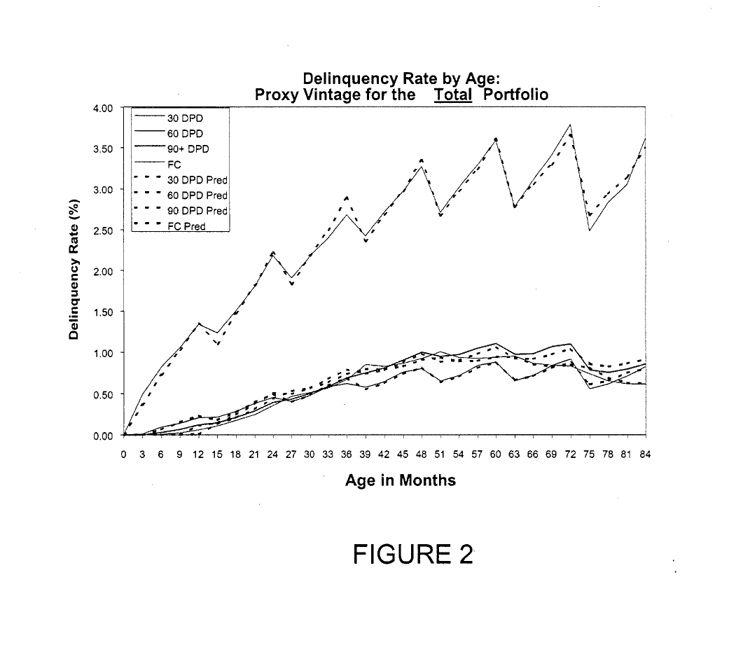

FIG. 2 illustrates the empirical delinquency rates by age of the proxy vintage of the total portfolio from the company LoanPerformance, and the predicted delinquency rates by age from the regression. As can be seen from this Figure, these two curves fit quite well.

The delinquency rate curve of the proxy vintage dynamically shows the relationship between the delinquency rate and the age. This proxy vintage performance curve reveals the empirical relationship between the delinquency rates at different ages. This relation can be estimated by the ratio of the two rates. Table 2 depicts the delinquency rate for the proxy vintage for ages 3 months through 48 months.

TABLE 2
Delinquency Rate and AADR (by Month) for the Proxy Vintage

| Age | | | | | | | | | | | | | | | | |
|---|---|---|---|---|---|---|---|---|---|---|---|---|---|---|---|---|
| (months) | 3 | 6 | 9 | 12 | 15 | 18 | 21 | 24 | 27 | 30 | 33 | 36 | 39 | 42 | 45 | 48 |
| 30 DPD | 0.49 | 0.82 | 1.06 | 1.34 | 1.24 | 1.51 | 1.80 | 2.18 | 1.91 | 2.17 | 2.40 | 2.68 | 2.42 | 2.71 | 2.97 | 3.27 |
| Age Adj. | 4.47 | 2.65 | 2.06 | 1.63 | 1.77 | 1.45 | 1.21 | 1.00 | 1.14 | 1.01 | 0.91 | 0.81 | 0.90 | 0.81 | 0.74 | 0.67 |
| Factor | | | | | | | | | | | | | | | | |

Let us first consider the 30 DPD rates of the proxy vintage. When the proxy vintage is 24 months old, the 30 DPD rate is 2.18 percent. When it is 36 months old, the 30 DPD rate is 2.68 percent. The relation between the 30 DPD rates at 24 months of age and at 36 months of age is determined by the ratio of the delinquency rate at 24 months to the delinquency rate at 36 months, that is, the ratio of 2.18/2.68=0.81.

This ratio is called the age adjustment factor. The numerator of this ratio is the delinquency rate of the proxy vintage at the age of 2 years (24 months). As can be seen from Table 2, the age adjustment factor is 1.00 when the vintage is at the 2 year age. This age, 2 years, is called the base age. As described above, the base age is used as a benchmark age of credit performance and can be set up by different choices. The criteria for determining the appropriate base age is typically the length of time from the first signs of delinquency (e.g. 30DPD) until the time the collateral is sold or the note is pursued and ajudgment is obtained. For home mortgages, this time period is typically two years. Different types of collateralized loans would have a different time periods. For example, for oil rigs the base age might be five years, and for automobiles the base age might be six months. One other factor to consider in determining the base age is the life expectancy of the asset.

In the example, depicted in Table 2, the age adjustment factor at age 36 months is 0.81. Since the proxy vintage has the pattern of the average vintage's performance (See FIGS. 1A-1D), it is reasonable to assume that all the vintage curves, same as the proxy vintage, will have the same ratio for the relation between the delinquency rates at different ages.

Under this assumption, if another vintage (not the proxy vintage) has a 30 DPD rate of 3.50 percent at the age of 36 months old, we can use the age adjustment factor from the proxy vintage to infer the 30 DPD at the base age of 2 years. Using the age adjustment factor of 0.81 for a 36 month old 30 DPD from table 2, the 30 DPD at the base age of the vintage in question would have been 3.50*0.81=2.84 percent. The advantage of this inferred rate is that it provides a common base for comparison of the credit performance of vintages with different ages.

Although Table 2 only illustrates the calculation of the age adjustment factor for the 30 DPD of the proxy vintage, as appreciated by those skilled in the art, similar vectors of age adjustment factor for the 60 DPD rate, 90+ DPD rate, and foreclosure rate of the proxy vintage should also be calculated for these delinquencies. The age adjustment factor for the 30 DPD is not applicable to the 60 DPD, the 90+ DPD or the foreclosure delinquency.

To fully develop this process of comparison, the present invention defines the base delinquency rate as the delinquency rate of the proxy vintage at the base age. For any vintage of an age other than the base age, the equivalent base delinquency rate is defined as the product of vintage's current delinquency rate by the requisite age adjustment factor. By definition, the equivalent base delinquency rate is: (i) a rate inferred from the vintage's current rate; (ii) determined by a factor derived from the experience of the proxy vintage; and (iii) an estimation of the delinquency rate at the base age.

The equivalent base rate combines the information on both the current delinquency rate of the vintage and its age into one rate, at one comparable point in time (the base age). Therefore, the equivalent base rate is a good candidate for a measure to compare the current delinquency performance of vintages at different ages. By comparing the equivalent base delinquency rates of vintages with different ages the present invention provides superior results to other approaches that compare the current rates alone without taking into account the age effects.

If the equivalent base rate of a vintage is less than the base rate, the present invention indicates that the vintage in question performs better than the average vintage (the proxy vintage). The reverse is also true. If the equivalent base rate of a vintage is greater than the base rate, the present invention says that the vintage in question has a worse credit performance than the proxy vintage. The equivalent base delinquency rate of the present invention is a new and more accurate measure to evaluate a vintage's credit performance. With this measure, the present invention has a new approach for the valuation of the credit performance of portfolios.

It should be noted that the development of the proxy vintage, and its associated age adjustment factors (as seen in Table 2) can be performed as often as new historical data becomes available. As described above, new historical data is typically released on a monthly basis. Although not strictly necessary, this new set of historical data would normally trigger a recalculation of the proxy vintage and age adjustment factors. Having the most recent data included in the proxy vintage leads to more accurate age adjustment factors and thus more accurate results when comparing the proxy vintage to vintages in question.

Most portfolios are comprised of several vintages. The present invention therefore takes the above described processes for determining the equivalent base delinquency rate for a single vintage and applies it to a portfolio containing several vintages. As described above, the method of the present invention first calculates the equivalent base delinquency rate for each vintage in the portfolio. The process then uses the thus calculated equivalent base delinquency rates to determine the Age Adjusted Delinquency Rate (AADR). AADR is the weighted average of the equivalent base delinquency rates of all the vintages in the portfolio. This single number of AADR has thus integrated the information from: the composition of the vintages in the portfolio; the ages of vintages; and the credit performance of each vintage.

As a measure of credit quality, the traditional approach using solely the delinquency rate of the vintages in a portfolio is easy to calculate, but produces a biased estimator because a major factor of age is not taken into account in the evaluation. By using equivalent base delinquency rate, the present invention compares the performance at the same base age. The AADR reduces the bias caused by variations of age of the loans.

The following example illustrates the operation of the AADR. In this example, there are two portfolios: A and B. And the objective is to compare the 30 DPD rates of the two portfolios. Table 3 gives some details on these two portfolios.

TABLE 3
Overall Delinquency Rate of Portfolios A and B

| | 30 DPD Rate |
|---|---|
| | (Sept. 30, 2001 |
| Portfolio A | 1.62 |
| Portfolio B | 1.96 |

The 30 DPD rate depicted in Table 3 is the weighted average 30 DPD of all of the vintages in each of the respective portfolios. Using the traditional approach of looking at the overall 30 DPD rate alone, one would conclude that Portfolio A performs better than Portfolio B. The overall 30 DPD rate of portfolio A is only 1.62, while the overall 30 DPD rate of Portfolio B is higher at 1.96. One would conclude that the 17% lower 30 DPD for Portfolio A indicates that Portfolio A has a better credit performance and is therefore worth more in the secondary market than Portfolio B.

The conclusion derived from the unadjusted delinquency rates though, is misleading. As stated above, the standard delinquency rate analysis is misleading because it does reflect the age effect on the vintages contained in the portfolio. Table 4 illustrates the composition of the vintages contained in Portfolios A and B.

TABLE 4
Portfolio Performance by Vintage

| | | Vintage | | | |
|---|---|---|---|---|---|
| | | Performance | | | Overall Portfolio |
| | | 2001 | 2000 | 1999 | Performance |
| Portfolio A | Composition | 60% | 30% | 10% | 100% |
| | 30 DPD Rate | 1.20 | 2.20 | 2.40 | 1.62 |
| | (Sept. 30, 2001) | | | | |
| Portfolio B | Composition | 10% | 30% | 60% | 100% |
| | 30 DPD Rate | 1.00 | 2.00 | 2.10 | 1.96 |
| | (Sept. 30, 2001) | | | | |

As can be seen from Table 4, Portfolio A is largely composed of much younger vintages. Of the loans in Portfolio A, 60% are of a 2001 vintage (originated in 2001), 30% are of a 2000 vintage and only 10% were originated in 1999. Clearly Portfolio A has increased origination in the last year and has a significantly large portion of young loans. In contrast, only ten percent of the loans in portfolio B were originated in 2001, 30% were originated in 2000 and the majority of loans, 60%, are in the 1999 vintage.

Looking at the 30 DPD rate for each of the vintages for the two portfolios, it can be seen that the delinquency rate for Portfolio A was worse for every vintage. The 2001 vintage of Portfolio A experienced a 1.20 delinquency rate while the comparable rate for Portfolio B was only 1.00. For the 2000 vintage, the 30 DPD for Portfolio A was 2.20, while Portfolio B performed better with a 30 DPD of 2.00. Finally, the 1999 loans in Portfolio A had a delinquency rate of 2.40 as compared to a 2.10 rate for Portfolio B.

The traditional delinquency rate analysis blindly combines these delinquency rates and results in an overall 1.62 rate for Portfolio A and a 1.96 rate for Portfolio B. Even though each of the vintages of Portfolio A performed worse than its counterpart vintage in Portfolio B, the overall rate for Portfolio B in the traditional analysis is worse (1.96) than the overall rate for Portfolio A (1.62). A closer look at the data reveals the reason for this skewing of the data. The bulk of the loans in Portfolio A (60%), are younger (2001 vintage) and performed better than the bulk of the loans in Portfolio B (60%) which are older (1999 vintage). This example makes clear the effect of the traditional delinquency rate analysis that ignores age. The primary purpose of the present invention's AADR is to correct this skewing of the traditional analysis and more accurately estimate the credit performance of a portfolio.

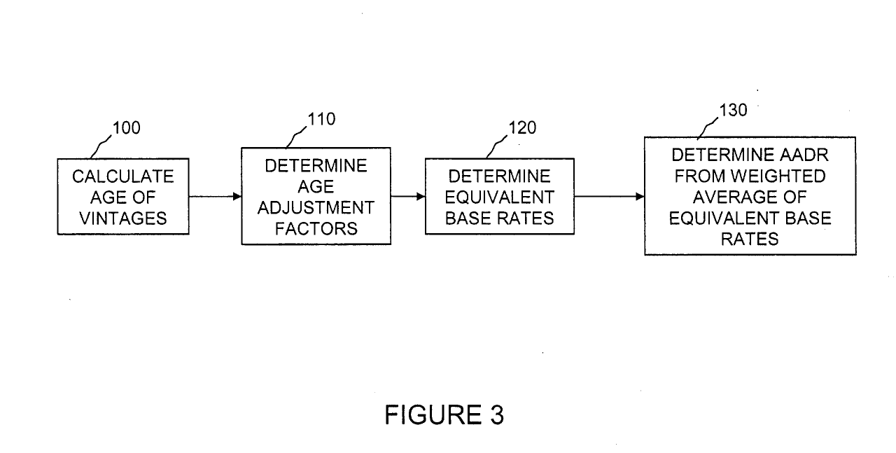

FIG. 3 illustrates the process of determining the AADR. As seen in Step 100, the first task is to determine the age of a vintage at the time of interest. In the present example, the time of interest is Sep. 30, 2001. Accordingly, the 2001 vintage loans are 9 months old, the 2000 vintages are 21 months old and the 1999 loans are 33 months old. These ages are shown in the “Age” row of Table 5.

The second step (Step 110) is to determine the age adjustment factors for ages of the vintages in question. The age adjustment factors were previously calculated with respect to the proxy vintage (see Table 2) As seen in Table 5, the age adjustment factor for a 9 month 30 DPD is 2.06. For the 21 month vintage, the age adjustment factor for the 30 DPD is 1.21. Finally, the age adjustment factor for the 33 month old loans is 0.91.

The third step (Step 120) is to determine the equivalent base rate for the delinquency in question. In this example, the delinquency is the 30 DPD. As described above, the equivalent base rate is the product of vintage's current delinquency rate by the requisite age adjustment factor. In the example illustrated in Table 5, the vintage's current 30 DPD delinquency rate was retrieved from Table 4 for each of the vintages in both Portfolios A and B. As illustrated in the Equivalent 30 DPD Base Rate row for each of the Portfolios, this equivalent base rate is the product of the vintage's current delinquency rate and the age adjustment factor. In the case of Portfolio A's vintages, the equivalent 30 DPD base rate were 2.47, 2.66 and 2.18 respectively for the 2001, 2000 and 1999 vintages. With respect to Portfolio B vintages, the equivalent 30 DPD base rate were 2.06, 2.42 and 1.91 respectively for the 2001, 2000 and 1999 vintages.

Without even taking into account the effects of weighting on the portfolio's loan distribution, it can be readily seen that the present invention's recognition of the contribution of the age effect is significant in assessing the credit performance of a portfolio. The equivalent delinquency rate of the 2001 loans (2.47 for Portfolio A and 2.06 for Portfolio B) is more than double the vintage's current delinquency rate (1.20 for Portfolio A and 1.00 for Portfolio B) Conversely, by factoring in the effects of age, the equivalent delinquency rate of the 1999 loans (2.18 for Portfolio A and 1.91 for Portfolio B) we actually reduced from their current levels of delinquency (2.40 for Portfolio A and 2.10 for Portfolio B).

In the final step (Step 130), the AADR is determined from the weighted average of the equivalent 30 DPD base rates for each of the vintages in each of the portfolios. The weighting of the present invention uses the loan composition as illustrated in Table 5. Performing this weighting, the AADR for Portfolio A is 2.50 (2.47*0.60+2.66*0.30+2.18*0.10). The AADR for Portfolio B is 2.15 (2.06*0.60+2.42*0.30+1.91*0.10).

Using the processes of the present invention, the AADR of Portfolio A was determined to be 2.50, while the AADR of Portfolio B was only 2.15. This is directly opposite conclusion that the traditional approach yielded. In the traditional approach, the average delinquency rate for Portfolio A was 1.62, while the average delinquency rate of Portfolio By was 1.96. The traditional approach advises that Portfolio A out-performed Portfolio B by 17% (with respect to delinquencies) while the present invention indicates that Portfolio B out-performed Portfolio A by 15%.

TABLE 5
AADR as a Measure of Portfolio Performance

| | | Vintage Performance | | | |
|---|---|---|---|---|---|
| | Vintage | 2001 | 2000 | 1999 | |
| Vintage | Age | 9 months | 21 months | 33 months | Overall Portfolio |
| Information | Age Adj. Factor | 2.06 | 1.21 | 0.91 | Performance |
| Portfolio A | Composition | 60% | 30% | 10% | 100% |
| | 30 DPD Rate | 1.20 | 2.20 | 2.40 | 1.62 |
| | (Sept. 30, 2001) | | | | (30 DPD Rate) |
| | Equivalent 30 | 2.47 | 2.66 | 2.18 | 2.50 |
| | DPD Base Rate | (1.20*2.06) | (2.20*1.21) | (2.40*0.91) | (AADR) |
| Portfolio B | Composition | 10% | 30% | 60% | 100% |
| | 30 DPD Rate | 1.00 | 2.00 | 2.10 | 1.96 |
| | (Sept. 30, 2001) | | | | (30 DPD Rate) |
| | Equivalent 30 | 2.06 | 2.42 | 1.91 | 2.15 |
| | DPD Base Rate | (1.00*2.06) | (2.00*1.21) | (2.10*0.91) | (AADR) |

Why is the conclusion from AADR different from the one from the overall rate? As described above, vintage 2001 in Portfolio A, whose age is very young and whose share of the portfolio is significant, performs much worse than its counterpart in Portfolio B. This is a warning for the future performance of Portfolio A that is detected by the AADR and ignored by the traditional approach. In this sense, AADR is better unbiased estimator than the overall delinquency rate.

So far, the present invention has been shown to include the features of the proxy vintage, a base age, an equivalent base delinquency rate and an age adjusted delinquency rate. These features have been shown to have utility in assessing the past credit performance of portfolios. The next section describes how the proxy vintage's performance can be used to predict the future performance of a vintage. Two approaches are described to predict a vintage's future delinquency rate based on the current vintage's performance information. The first process is used to predict a particular vintages' future delinquency rate. The second process generates a prediction with respect to a prediction by weighting each vintage's prediction.

Both processes can be best explained by using an example of fictitious Vintage P. Table 6 below contains the data about the proxy vintage and Vintage P, including: the proxy vintage's 30 DPD rates by age, and the 30 DPD rates of Vintage P up to the age of 12 months.

TABLE 6
30 DPD for Proxy Vintage and Vintage P

| Age | | | | | | | | | | | | | | | | |
|---|---|---|---|---|---|---|---|---|---|---|---|---|---|---|---|---|
| (months) | 3 | 6 | 9 | 12 | 15 | 18 | 21 | 24 | 27 | 30 | 33 | 36 | 39 | 42 | 45 | 48 |
| Proxy | 0.49 | 0.82 | 1.06 | 1.34 | 1.24 | 1.51 | 1.80 | 2.18 | 1.91 | 2.17 | 2.40 | 2.68 | 2.42 | 2.71 | 2.97 | 3.27 |
| Vintage | | | | | | | | | | | | | | | | |
| Vintage P | 0.51 | 1.05 | 1.33 | 1.55 | | | | | | | | | | | | |

The first prediction process is denoted the “average quarterly change prediction”. In this approach, it is assumed that the current delinquency rate of Vintage P decides the rate variance from the proxy vintage. From the 12th month going forward, the process assumes that Vintage P will perform as the proxy vintage in the sense that the two vintages will have the same the quarterly delinquency rate changes. Therefore, in order to predict the future delinquency rate of Vintage P, the process first determines the quarterly changes of the 30 DPD rate of the proxy vintage from the age of 15 months on. This quarterly change is illustrated in Table 7. Although only data through the 36th month is included in Table 7, it is appreciated by those skilled in the art that the data can be extended out for any number of months. The proxy vintage data, preferably from LoanPerformance, has historical data extending back years.

TABLE 7
30 DPD for Proxy Vintage and Vintage P

| Age | | | | | | | | | | | | |
|---|---|---|---|---|---|---|---|---|---|---|---|---|
| (months) | 3 | 6 | 9 | 12 | 15 | 18 | 21 | 24 | 27 | 30 | 33 | 36 |
| Proxy | 0.49 | 0.82 | 1.06 | 1.34 | 1.24 | 1.51 | 1.80 | 2.18 | 1.91 | 2.17 | 2.40 | 2.68 |
| Vintage | | | | | | | | | | | | |
| Quarterly | | | | | −0.10 | 0.27 | 0.30 | 0.38 | −0.28 | 0.26 | 0.23 | 0.28 |
| Change | | | | | | | | | | | | |
| Vintage P | 0.51 | 1.05 | 1.33 | 1.55 | | | | | | | | |
| Prediction | | | | | 1.45 | 1.72 | 2.01 | 2.39 | 2.12 | 2.38 | 2.61 | 2.89 |

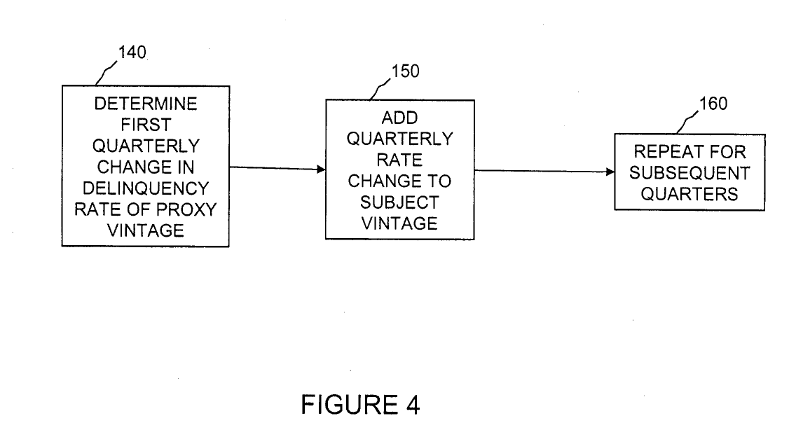

As seen in Table 7 and in FIG. 4, the first step in the process (Step 140) is to determine the quarterly change in the delinquency rate of the proxy vintage. The first quarterly change of interest in the present example is from month 12 to month 15. This change is calculated by subtracting the delinquency rate in the 12th month (1.34) from the rate in the 15th month (1.24). This results in a quarterly change of −0.10%. To predict the first rate of Vintage P at the age of 15 months, the process of the present invention in step 150 adds the first quarterly change of −0.10% to the rate of 1.55% of Vintage P at the age of 12 months. The resultant predicted rate for Vintage P at the age of 15 months is 1.55%+(−0.10%)=1.45%.

Continuing on, the predicted rate for Vintage P at the age of 18 months is the first predicted rate of Vintage P 1.45% plus the second quarterly changes of 0.27%, which is 1.72%. The process is repeated in Step 160 for each subsequent quarter and is shown in the Table 7. Following the above process, the delinquency rate for the entire time series for Vintage P can be predicted. Intuitively, the average quarterly change prediction curve by age is the corresponding part of the proxy vintage's curve “lifted” vertically to the last point of the known delinquency rate curve of Vintage P for prediction. This approach is conservative, because it is assumed that its past performance only effects the starting point of the prediction (the base). From this base forward, the quarterly changes of Vintage P are no longer differentiable from the proxy vintage, i.e. the average historical vintage.

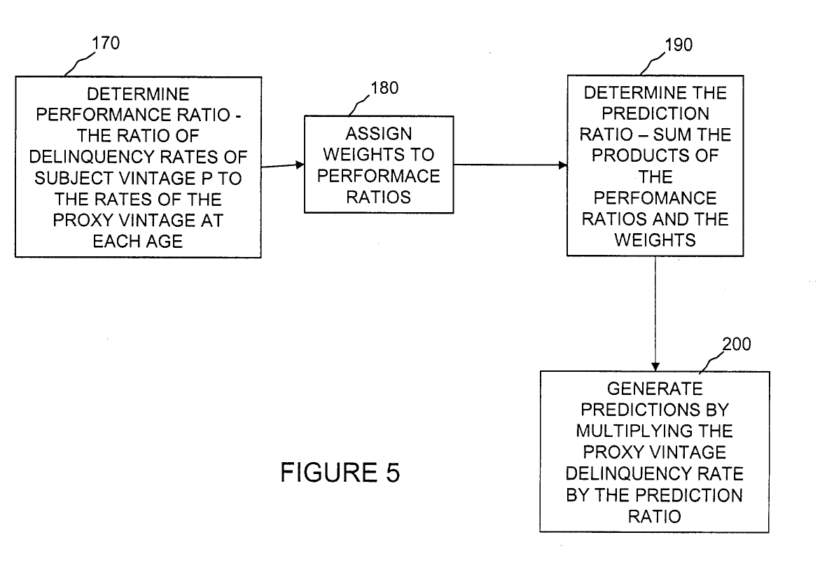

The second prediction process of the present invention is denoted the “average ratio prediction.” In this process, as illustrated in FIG. 5 it is assumed that the existing history of the performance of Vintage P has shown its performance variance from the proxy vintage's and it will perform with the same variance in the future. To capture the variance, the process first, in step 170, determines the ratio of the known delinquency rate of Vintage P to the rates of the proxy vintage at each age. The ratio is denoted as the performance ratio and is a function of the age up to the current time.

All the performance ratios for all the ages play roles in the future performance. However, it is assumed that the most recent performance ratio has biggest effects. Accordingly a weighted average of the performance ratios, denoted a prediction ratio, serves as the adjustment factor to the proxy vintage's delinquency rate to get the prediction for the Vintage P. The weight for each performance ratio should be estimated by empirical data, but for the simplicity of calculation herein, the most current performance ratio is assigned a weight of 50%, the previous one has a weight of 30% and the second previous one has a weight of 20%. The weights are assigned to the respective performance ratios in step 180.

TABLE 8
Prediction of Vintage P performance using Prediction Ratio Method

| Age | | | | | | | | | | | | |
|---|---|---|---|---|---|---|---|---|---|---|---|---|
| (months) | 3 | 6 | 9 | 12 | 15 | 18 | 21 | 24 | 27 | 30 | 33 | 36 |
| Proxy | 0.49 | 0.82 | 1.06 | 1.34 | 1.24 | 1.51 | 1.80 | 2.18 | 1.91 | 2.17 | 2.40 | 2.68 |
| Vintage | | | | | | | | | | | | |
| Vintage P | 0.51 | 1.05 | 1.33 | 1.55 | | | | | | | | |
| Performance | 1.04 | 1.28 | 1.26 | 1.16 | | | | | | | | |
| Ratio | | | | | | | | | | | | |
| Prediction | | | | | 1.50 | 1.83 | 2.18 | 2.64 | 2.31 | 2.63 | 2.91 | 3.25 |

Table 8, illustrates the prediction ratio method as applied to Vintage P. The first step is to calculate the performance ratio for month three. This is accomplished by dividing the 3 month 30 DPD rate of Vintage P (0.51) by the 3 month 30 DPD rate of the proxy vintage (0.49) thus yielding a performance ratio of 1.04. The second, third and fourth quarter changes are similarly calculated by dividing the delinquency rate of Vintage P by the delinquency rate of the proxy vintage, thus yielding performance ratios of 1.28, 1.26 and 1.16 respectively.

The process then uses the above described weighting to determine the prediction ratio in step 190. Specifically, the most recent performance ratio (1.16) is multiplied by the weight of 50%, the next most recent performance ratio (1.26) is multiplied by 30% and the second most recent performance ratio (1.28) is multiplied by 20%. The resulting prediction ratio is 1.214. As described above, in the preferred embodiment, the weight for each performance ratio should be estimated by empirical data.

With the prediction ratio in hand, the process of the present invention, in step 200, generates predictions for the delinquency rate of Vintage P by multiplying the delinquency rate of the proxy vintage for a particular quarter by the prediction ratio. For example, the predicted delinquency rate for the next quarter (month 15) is the proxy vintage delinquency rate (1.24) times the prediction ratio (1.214) resulting in a prediction of a delinquency rate of 1.50. Similarly, the predictions of the remainder of the future delinquency rates of Vintage P is the delinquency rate of the proxy vintage at each future age times the prediction ratio.

The prediction ratio method vertically amplifies the curve of delinquency rate of the proxy vintage's future by the same average ratio. This method is more aggressive because the average ratio, therefore, the past performance of Vintage P, affects all the prediction of rates in the future.

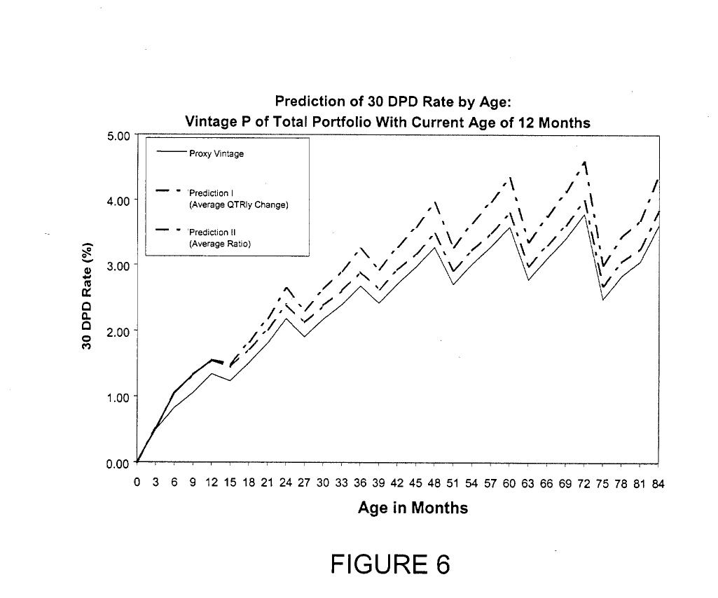

The results of the two predictions method of the present invention and the empirical rates of the proxy vintage and Vintage P are shown FIG. 6. The rate of the proxy vintage and the and the known rate of the Vintage P are in the solid line. The dotted lines of the Prediction I and the Prediction II are from the first and second approach respectively. The second prediction method is more aggressive as can been seen in FIG. 4.

So far, only vintages in a total portfolio have been discussed. The methods and processes of the present invention though, are easily extended to vintages in a particular program and product. The following discusses the differences of the delinquency performances between programs and products. Even though one skilled in the art intuitively knows the difference exists, the processes of the present invention quantifying this difference. Because there are so many programs and products in the mortgage business, only some of them can be discussed to show the present invention's approach to these issues.

Although most analysts in the mortgage industry intuitively know that the performance between government and conventional loans perform quite differently, it is not easy to quantify the difference. However, using the present invention's feature of the proxy vintage and applying regression on the proxy vintage, the present invention provides a tool for quantitative comparison.

Tables 9 and 10 are regression results on the proxy vintage for conventional loans and government loans respectively.

TABLE 9
Regression Analysis on the Proxy Vintage of Conventional Loans

| | R Square | Intercept | Mon_SQR | Month | Mar_Effect | June_Effect | Sept_Effect |
|---|---|---|---|---|---|---|---|
| 30 DPD | 0.983 | 0.2795 | −0.0004 | 0.0663 | −0.3464 | −0.2384 | −0.1504 |
| 60 DPD | 0.979 | −0.0576 | −0.0001 | 0.0180 | −0.0697 | −0.0551 | −0.0185 |
| 90+ DPD | 0.952 | −0.1697 | −0.0001 | 0.0198 | −0.0278 | −0.0315 | −0.0203 |
| FC | 0.963 | −0.2876 | −0.0002 | 0.0265 | 0.0129 | −0.0112 | −0.0149 |

TABLE 10
Regression Analysis on the Proxy Vintage of Government Loans

| | R Square | Intercept | Mon_SQR | Month | Mar_Effect | June_Effect | Sept_Effect |
|---|---|---|---|---|---|---|---|
| 30 DPD | 0.960 | 1.0563 | −0.0020 | 0.2322 | −1.1172 | −0.7182 | −0.4059 |
| 60 DPD | 0.985 | −0.0857 | −0.0007 | 0.0836 | −0.3912 | −0.2696 | −0.0975 |
| 90+ DPD | 0.982 | −1.1121 | −0.0014 | 0.1597 | −0.3284 | −0.2927 | −0.1594 |
| FC | 0.971 | −1.6168 | −0.0016 | 0.1694 | 0.0552 | −0.1103 | −0.0948 |

There are some conclusions can be drawn from the regression contained in Tables 9 and 10 above: seasonal effects; the speed of increasing of the delinquency rate; and the mature age.

In regard to the seasonal effects, by comparing the same effects of 35 basis points (bps), 24 bps, 25 bps respectively for conventional loans, it can be seen from Tables 8 and 9 that government loans swing more wildly than the conventional loans. Therefore, the more serious seasonal effects take place in the government loans. Specifically For 30 DPD rate: the second year's March effect is 112 bps, which is better than in December; and June' effect is 72 bps and September's effect is 41 bps better than in December respectively. It should be noted that the 90 DPD rate for conventional loans and FC rate for conventional and government loans have no statistically significant seasonal effects

With respect to the speed of increasing of the delinquency rate, without considering the seasonal effect, the government loan's 30 DPD rate increases at a speed of 23 bps per month when the loans are young, compared with the conventional loans at a speed of 7 bps per months. The speed of the 60 DPD rate, 90 DPD rate and the foreclosure rate for government loans are about 6 times faster than for the conventional loans.

With regard to the mature age, again ignoring the seasonal effects, the delinquency rate is a quadratic function of the age. The regression analysis of Tables 8 and 9 shows that the peak of the government loans' 30 DPD rate is at the age of 58 months old, while the conventional loans at the age of 83 months old.

Similar observations can be drawn for the performing the above described regression analysis on 15 versus 30 year loans, conventional Adjustable Rate Mortgage (ARM) versus Fixed Rate Mortgage (FRM) loans; and government ARM versus FRM.

As clearly outlined above, the particular program or product can have a significant effect on the delinquency rate of the loans contained in a portfolio. Furthermore, the credit performance of the portfolio also differs because of the effect of other variables such geographic distribution. However, usually the biggest effect is caused by age. It was shown above that the AADR feature of the present invention improves the evaluation of the portfolio performance by reducing the bias caused by the deviation of the loan age in the portfolio.

In order to reduce the bias of these other factors, the feature of the AADR is extended to a new feature denoted characteristic adjusted delinquency rate (CharADR). Conceptually, AADR is a special form of CharADR where age is the characteristic of interest. If one of the other factors is varied, it is CharADR.

The feature of CharADR is best illustrated by the following example. Assume that one is interested in evaluating a group of portfolios, each of which have a significantly different composition of government loans, conforming loans and jumbo loans; and also varying amounts of ARM and FRM loans. Although the AADR of the portfolio reduces the bias caused by age, the bias caused by these other characteristics is also significant.

One method is to first obtain an AADR for each sub-portfolio defined by the characteristics. In this example, there are 3*2=6 sub-portfolios: Government ARM, Government FRM, Conventional Conforming ARM, Conventional Conforming FRM, Conventional Non-Conforming ARM, and Conventional Non-Conforming FRM.

By analyzing the sub-portfolios, the characteristic effect is reflected by the AADR of each sub-portfolio, but is not biased due to loans' sharing common characteristics in each sub-portfolio. There are two questions that remain though. How does one compare the credit performance between the sub-portfolios? How does one build one unbiased statistic based on the information on all the sub-portfolios as a measure of the credit performance of the whole portfolio, which can be easily be used to compare the credit performance between different portfolios?

The key solutions to those two questions provided by the present invention use the proxy vintages and their AADRs. For each sub-portfolio, the process uses the empirical performance data (such as from LoanPerformance) to define a proxy vintage and find out its AADR. In this example, there are six proxy vintages corresponding to the six different sub-portfolios. For purpose of comparison, one of the sub-portfolios is designated as the base sub-portfolio, so that its credit performance can be served as a comparable base to the credit performance of other sub-portfolios. Its corresponding proxy vintages are further designated as the base proxy vintage, and the AADR of this base proxy vintage is designated as the base AADR.

Since all the proxy vintages have empirical performance related to the specified characteristics, the differences between the AADRs of those vintages result mainly from the differences of the characteristics. Therefore, the present invention defines a ratio of the AADR of each proxy vintage to that of the proxy vintage as a measure of characteristic effect. This ratio is denoted the C-ratio. To illustrate how a C-ratio works, if the base sub-portfolio is Conforming FRM, and the C-ratio of the Government ARM sub-portfolio is =½, then the AADR of the Government ARM sub-portfolio is twice as high as that rate for the Conventional Conforming FRM sub-portfolio. After thus defining the C-ratio, the solutions to the above two questions can be presented.

The process defines the equivalent base AADR of a sub-portfolio (EBAADR) as the product of its AADR times its C-ratio. The original AADR of a sub-portfolio is the inferred delinquency rate of the sub-portfolio at the base age of two years old. However, this is highly correlated with the characteristics of the sub-portfolio. This fact makes it very difficult to compare the performance between sub-portfolios. EBAADR provides a common performance base on which AADRs of all the sub-portfolios are transferred to that of the base sub-portfolio by the C-ratios, which is a measure of the characteristics' effects.

After the EBAADR has been determined for each of the sub-portfolios, the CharADR can be generated for the entire portfolio. CharADR is the weighted average of EBAADRs of all sub-portfolios by their shares in the portfolio. CharADR is better as an estimator of the credit quality of a portfolio than AADR and much better than traditional delinquency rate. This is because, the CharADR combines the loan information of delinquency rate, age and characteristics in one single statistic. The bias which comes from the age and the characteristics is accordingly reduced.

The steps inc construction of the CharADR are demonstrated with respect to Tables 11 and 12.

TABLE 11
The Process of the Calculation the CHARADR of the Total Portfolio:

| | Total Portfolio | | | | | |
|---|---|---|---|---|---|---|
| | | | Conventional | | | |
| | Government | | Conforming | | Conventional Non-Conf. | |
| | Gov. | | Conf. | Conf. FRM | Non-Conf. | Non-Conf. |
| Sub Portfolio | ARM | Gov. FRM | ARM | (Base) | ARM | FRM |
| Proxy Vintage | I | II | III | Base | V | VI |
| AADR of | P1 | P2 | P3 | P4 | P5 | P6 |
| Proxy Vintage | | | | | | |
| C-Ratio | R1 = P4/P1 | R1 = P4/P2 | R1 = P4/P3 | 1.00 | R1 = P4/P5 | R1 = P4/P6 |
| Share | S1 | S2 | S3 | S4 | S5 | S6 |
| AADR | A1 | A2 | A3 | A4 | A5 | A6 |
| EBAADR | E1 = A1*R1 | E2 = A2*R2 | E3 = A2*R3 | E4 = A4 | E5 = A5*R5 | E6 = A6*R6 |

| | |
|---|---|
| CHARADR | CHARADR = E1*S1 + E2*S3 + E3*S3 + E4*S4 + E5*S5 + E6*S6 |

Following the previous example, one can use the CharADR approach to compare the performance of Portfolio A and Portfolio B more accurately by considering the two more characteristics of the portfolios: one is the loan type (Government/conventional conforming/conventional non-conforming) and the other is the interest type (ARM/FRM). Both Portfolio A and Portfolio B are segmented into six sub-portfolios: Government ARM, Government FRM, Conventional Conforming ARM, Conventional Conforming FRM, Conventional Non-Conforming ARM, and Conventional Non-Conforming FRM. We calculate the 30 AADR for the proxy vintage and the C-ratio for each sub-portfolio from the Proxy Vintage Database. Following the process in Table 11, we can get the final results of 30 Day CHARADR are 1.62 for Portfolio A and 1.48 for Portfolio B, which indicates that Portfolio B performs 9.5% better than Portfolio B with consideration of the two characteristics.

TABLE 12
The 30DPD CHARADR of Portfolio A and Portfolio B:

| | Total Portfolio | | | | | | |
|---|---|---|---|---|---|---|---|
| | | | Conventional | Conventional | Conventional | Conventional | |
| Sub-Portfolio | Gov ARM | Gov FRM | Conf. ARM | Conf. FRM | Non-conf ARM | Non-conf FRM | |
| Proxy | I | II | III | Base | V | VI | CharADR |
| Vintage | | | | | | | |
| AADR of | 6.65 | 5.76 | 1.57 | 1.62 | 1.12 | 1.06 | |
| Proxy Vintage | | | | | | | |
| C-Ratio | 0.24 | 0.28 | 1.03 | 1.00 | 1.45 | 1.53 | |
| Share | 7% | 28% | 15% | 32% | 10% | 9% | 1.62 |
| AADR | 4.08 | 4.20 | 1.10 | 1.91 | 0.79 | 2.45 | |
| EBAADR | 0.99 | 1.18 | 1.14 | 1.91 | 1.14 | 3.74 | |
| Share | 4% | 34% | 11% | 33% | 7% | 12% | 1.48 |
| AADR | 2.87 | 3.24 | 1.03 | 1.71 | 0.90 | 2.02 | |
| EBAADR | 0.70 | 0.91 | 1.06 | 1.71 | 1.31 | 3.09 | |

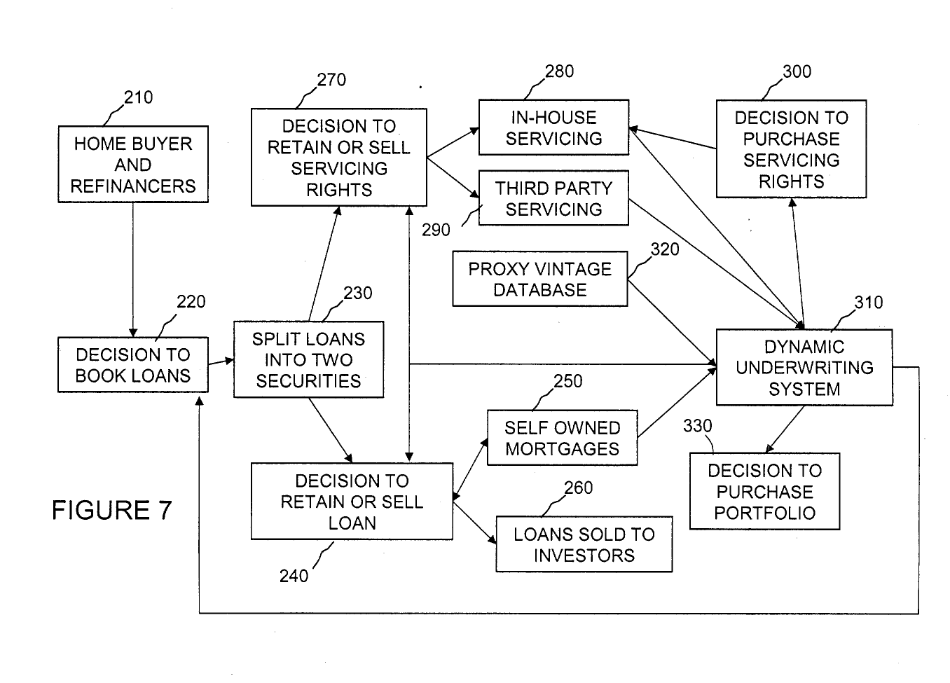

The general environment for the method and system of the present invention can be better appreciated by reference to FIG. 7. As illustrated therein, home buyers and refinanciers 210 typically submit applications for loans to one or more financial institutions 220. These institutions include loan granting departments that decide whether or not to book given loans by applying various credit screens, i.e. criteria. One screen may focus on the applicable LTV (loan to value) of a transaction, the D/I (debt to income) ratio of the involved transaction and/or on the credit history of the particular applicant.

Based on the aforementioned and other criteria, a decision is made to accept or reject a particular loan application. Each loan that has been accepted is added as another loan unit to a large portfolio of similar families of loans, e.g. conforming loans, jumbo loans, government loans, etc. A loan typically has a loan start date and a date by which the loan is expected to be fully paid up, as is typical of home mortgage loans. A loan that is issued for a fixed amount and period of time is known in the trade as a closed loan. These closed loans are artificially split and treated as two business securities or entities—namely as a “loan” entity and as a “servicing” right, as indicated at 230.

Each loan unit or instrument represents to the financial institution an opportunity to earn a profit on the differential between its cost of money and the amount of interest earned from the borrower. Another profit component is realizable from the servicing element of each loan entity. That is, a finite budget for labor and equipment use must be allocated when the loan is issued to service each loan over its life time. The banking trade has traditionally derived substantial revenues from the servicing of loan portfolios, to the extent that they were able to service loans at a cost below the originally calculated service allocation. Consequently, banks and other financial institutions sometimes trade loan “servicing” contracts. These contracts are routinely purchased and sold in large units since they represent income opportunities. For example, a bank which lacks a servicing department might contract with another bank to service its loans at a set, per loan pricing arrangement. The bank that purchases the contract does so with the expectation of earning a profit on the project. If it develops later that a particular loan portfolio experiences a large rate of defaults, the extra servicing needed to collect funds on the loans might render the particular servicing contract unprofitable. In such a situation, the service organization might attempt to resell the service contract to another service organization which might be interested in it, for example, at an increased service rate.

With further reference to FIG. 7, block 240 represents the department of the financial institution which makes the decision whether to retain or sell a particular loan portfolio. Typically these loans are sold in very large blocks, each containing thousands of individual loan units. Those loan units originating at block 220 that are retained by the given financial institution are represented by block 250. On the other hand, as indicated by the block 260, a portion of the book of loans is sometimes sold off to investors and is securitized. Therefore, it will be appreciated that selling and purchasing loan portfolios requires careful examination of various loan product lines to assess their viability, profitability and related factors.

As already noted, another source of profit flows from the servicing portion of the loans. Block 270 identifies the step which decides whether to retain or sell the servicing component of a loan portfolio. Those loans for which servicing is retained are serviced at the bank which originated the loans as indicated at 280. The servicing of the balance of the loans procured at block 220 is contracted out to third parties for services as indicated at block 290. In addition, the servicing end 280 of the banking business is also able to purchase the servicing rights as indicated at 300.

As described above, the banking industry distinguishes between ownership of loans and the servicing thereof. Loans that are owned by a given financial institution can be serviced by that institution's own servicing subsidiary or the servicing part can be contracted to third party servicing bureaus. Indeed, not all financial institution have loan servicing departments. Conversely, a bank with a servicing organization can purchase the “servicing” component associated with loans owned by other banks and render the servicing thereon.

In any case, it is self-evident that the profits from earning interest on loan portfolios and from the loan servicing line of business is heavily influenced by the performance of various loan groups vis-a-vis the default rate of these loans over the life of the loans, foreclosures, collection efforts, loan prepayment and the like. Loan portfolios which experience low default rates are easy to service and are highly profitable to financial institutions.

Traditionally, the decision to purchase, retain, sell or create loan portfolios demands critical analysis of the past performance of the loan portfolios under consideration. Moreover, such decisions invariably implicate assumptions and predictions as to how such loan portfolios will perform in the future. Not surprisingly, the decisions to book loans at block 220 typically depended on and required analysis and consideration by highly skilled and experienced persons having very keen and sharp analytical powers to determine the potential profitability of loan portfolios being considered.

The present invention departs from the prior art by providing a dynamic underwriting system 310. The dynamic underwriting method and system 310 performs the processes described above in order to assess the credit performance of portfolios in order to make the purchase, sale and servicing rights decisions described above. In performing these operations, the dynamic underwriting system 310 uses a proxy vintage database 320 as described above. The information obtained from the dynamic underwriting system 310 is applied, via feedback lines to the decisions in 220, 300, 270, 240 as well as the decision to purchase a portfolio 330. This feedback process of the present invention is systemized and provides a standardized approach to forming the decisions whether to book loans and service loans. The invention substantially increases the reliability, consistency and speed of the loan acceptance decision process as well as the decisions to purchase and service loans and portfolios.

As appreciated by those skilled in the art, the system of the present invention is preferably a distributed system having a client-server architecture including client servers, application servers and data servers. These servers are typically connected to one another via a conventional TCP/IP-based data network, such as the Internet or a private corporate Intranet. It is further appreciated by those skilled in the art that the system may alternatively be distributed across a Wide Area Network (WAN); may reside entirely on a Local Area Network (LAN); or may be accessed via a dial-up connection.

Although the present invention has been described in relation to particular embodiments thereof, many other variations and other uses will be apparent to those skilled in the art. It is preferred, therefore, that the present invention be limited not by the specific disclosure herein, but only by the gist and scope of the disclosure.

We claim:

1. A method for evaluating the credit performance of a portfolio of loans comprising:
a) obtaining a proxy vintage database containing data from a large pool of loans, the proxy vintage database being organized into proxy vintages according to the ages of the loans, each of the proxy vintages having an average delinquency rate of the loans contained therein, one of the proxy vintages being denoted as a base proxy vintage;
b) determining an age adjustment factor for each of the proxy vintages by dividing the average delinquency rate of the base proxy vintage by the average delinquency rate of the proxy vintage;
c) creating portfolio vintages from the loans in the portfolio loans according to their ages;
d) determining delinquency rates of each of the portfolio vintages;
e) determining an equivalent base rate for each of the portfolio vintages by multiplying the delinquency rate of a portfolio vintage by the age adjustment factor of a proxy vintage having a comparable age; and
f) combining equivalent base rates for the portfolio groups into a single age adjusted delinquency rate.

2. The method according to claim 1, wherein the proxy vintage database contains delinquency data selected from the group consisting of 30 Days Past Due, 60 Days past Due, 90+ Days Past Due and In Foreclosure.

3. The method according to claim 1, wherein a granularity of the ages of the proxy vintages is quarterly.

4. The method according to claim 1, wherein the ages of the proxy vintages and the ages of the portfolio vintages are measured relative to an origination date of a loan.

5. The method according to claim 1, wherein the combining step further comprises weighting the portfolio vintages during the combining step.

6. The method according to claim 5, wherein the weighting step further comprises assigning a respective weight to each of the portfolio vintages and wherein the combining step further comprises adding the products of the respective weights and the delinquency rates of their corresponding portfolio vintages.

7. The method according to claim 6, wherein the weights are determined according to the number of loans in a portfolio vintage relative to the total number of loans in the portfolio.

8. The method according to claim 1, wherein the base age is determined according to a length of time required to sell collateral securing the loan.

9. The method according to claim 8, wherein the base age is two years.

10. The method according to claim 1, wherein the loans are closed end loans.

11. The method according to claim 10, wherein the loans are mortgages.

12. The method according to claim 1, further comprising:
separating the portfolio and the proxy vintage database into sub-portfolios;
designating one of the sub-portfolios of the proxy vintage database as a base sub-portfolio;
performing steps b) through f) for each of the sub-portfolios of the proxy vintage database and the portfolio;
for each of the sub-portfolios in the proxy vintage database, determining a C-ratio, the C-ratio being a ratio of the age adjusted delinquency rate of the base sub-portfolio and the sub-portfolio at the base age.
for each of the sub-portfolios in the portfolios, determining an equivalent base age adjusted delinquency rate by multiplying the age adjusted delinquency rate for that sub-portfolio by the C-ratio for the corresponding proxy vintage database sub-portfolio; and
combining the equivalent base age adjusted delinquency rates to generate a single characteristic adjusted delinquency rate for the portfolio.

13. The method according to claim 12, wherein the combining step further comprises weighting the equivalent base age adjusted delinquency rates during the combining step.

14. The method according to claim 13, wherein the weighting step further comprises assigning a respective weight to each of the equivalent base age adjusted delinquency rates and wherein the combining step further comprises adding the products of the respective weights and the equivalent base age adjusted delinquency rates of their corresponding sub-portfolios.

15. The method according to claim 14, wherein the weights are determined according to the number of loans in a portfolio group relative to the total number of loans in the portfolio.

16. The method according to claim 12, wherein the separating step further comprises separating the portfolio and the proxy vintage database into sub-portfolios according to a characteristic of the portfolio and the proxy vintage.

17. The method according to claim 16, wherein the characteristic is a type of mortgage.

18. The method according to claim 17, wherein the type of mortgages is selected from the group consisting of Government Adjustable Rate Mortgages, Government Fixed Rate Mortgages, Conventional Conforming Adjustable Rate Mortgages, Conventional Conforming Fixed Rate Mortgages, Conventional Non-Conforming Adjustable Rate Mortgages, and Conventional Non-Conforming Fixed Rate Mortgages.

19. The method according to claim 1, further comprising, using the age adjusted delinquency rate in taking an action with respect to the portfolio.

20. The method according to claim 19, wherein the action with respect to the portfolio is purchasing the portfolio.

21. The method according to claim 19, wherein the action with respect to the portfolio is selling the portfolio.

22. A method of predicting the future credit performance of a portfolio comprising:
a) obtaining a proxy vintage containing delinquency rates for a large pool of loans;
b) determining a most recent age at least one vintage of the portfolio, the age being denoted a vintage age;
c) determining a change between a delinquency rate of the proxy vintage at an age corresponding to the vintage age and a delinquency rate at an immediately preceding age;
d) generating a predicted delinquency rate by adding the change to a delinquency rate of the portfolio at the most recent age; and
e) repeating steps c) and d) for successive ages of the proxy vintage, thereby generating a time series of predicted delinquency rates for the portfolio.

23. The method according to claim 22, wherein the proxy vintage contains delinquency data selected from the group consisting of 30 Days Past Due, 60 Days past Due, 90+ Days Past Due and In Foreclosure.

24. The method according to claim 22, wherein a granularity of the ages of the proxy vintage and the portfolio is quarterly.

25. The method according to claim 22, wherein the ages of the proxy vintage and the ages of the portfolio are measured relative to an origination date of a loan.

26. The method according to claim 22, wherein the loans are closed end loans.

27. The method according to claim 22, wherein the loans are mortgages.

28. A method of predicting the future credit performance of a portfolio comprising:
a) obtaining a proxy vintage containing delinquency rate data for a large pool of loans;
b) for at least two ages of at least one vintage of the portfolio, determine a ratio between the delinquency rate at an age of the portfolio to a delinquency rate of the proxy vintage at a corresponding age, the ratios being denoted performance ratios;
c) assigning respective weights to at the performance ratios;
d) generating a prediction ratio by summing the products of the at least two performance ratios by their respective weights; and
e) generating predicted delinquency rates for the at least one vintage of the portfolio by multiplying the prediction ratio by successive delinquency rates of the proxy vintage.

29. The method according to claim 28, further comprising determining a performance ratio for each of the ages of the portfolio.

30. The method according to claim 28, wherein the weights are determined by empirical data.

31. The method according to claim 28, wherein the most current age of the portfolio is given the largest weight.

32. A system for evaluating the credit performance of a portfolio of loans comprising:
a proxy vintage database containing data from a large pool of loans, the proxy vintage database being organized into proxy vintages according to the ages of the loans, each of the proxy vintages having an average delinquency rate of the loans contained therein, one of the proxy vintages being denoted as a base proxy vintage;
a dynamic underwriting processing system, the dynamic underwriting processing system performing the following processing:
a) determining an age adjustment factor for each of the proxy vintages by dividing the average delinquency rate of the base proxy vintage by the average delinquency rate of the proxy vintage;
b) creating portfolio vintages from the loans in the portfolio loans according to their ages;
c) determining delinquency rates of each of the portfolio vintages;
d) determining an equivalent base rate for each of the portfolio vintages by multiplying the delinquency rate of a portfolio vintage by the age adjustment factor of a proxy vintage having a comparable age; and
e) combining equivalent base rates for the portfolio groups into a single age adjusted delinquency rate.

33. The system according to claim 32, wherein the proxy vintage database contains delinquency data selected from the group consisting of 30 Days Past Due, 60 Days past Due, 90+ Days Past Due and In Foreclosure.

34. The system according to claim 32, wherein the ages of the proxy vintages and the ages of the portfolio vintages are measured relative to an origination date of a loan.

35. The method according to claim 32, further comprising:
a decision engine, the decision engine making decisions with respect to the portfolio; and
a feedback loop from the dynamic underwriting system to the decision engine, wherein the age adjusted delinquency rate is fed back to the decision engine to assist in taking an action with respect to the portfolio.
